(19) United States
(12) Patent Application Publication
(10) Pub. No.: US 2024/0020248 A1
(43) Pub. Date: Jan. 18, 2024

(54) PARTIAL DATA HANDLING HARDWARE

(71) Applicant: Intel Corporation, Santa Clara, CA (US)

(72) Inventor: Kamlesh Pillai, Bangalore (IN)

(21) Appl. No.: 18/475,710

(22) Filed: Sep. 27, 2023

(51) Int. Cl. G06F 13/16; G06F 12/02

(52) U.S. Cl. CPC G06F 13/1673; G06F 12/023; G06F 2212/251

(57) ABSTRACT

Systems, apparatuses and methods may provide for technology that includes a first check buffer to remove first intermediate partial data and first incoming partial data from a first pipeline of the first check buffer in response to a first accumulation condition in which the first intermediate partial data and the first incoming partial data share a first address in a memory, combine the first intermediate partial data and the first incoming partial data to obtain first accumulated partial data, and insert the first accumulated partial data into the first pipeline. The first address may be in either a memory bank non-collision state or a memory bank collision state.

### TECHNICAL FIELD

Embodiments generally relate to data handling in artificial intelligence (AI) compute operations. More particularly, embodiments relate to optimized partial data handling hardware for real world AI applications with N-dimensional scene understanding.

### BACKGROUND

Many real world problems such as autonomous driving, automated machines, remote sensing, augmented reality (AR), virtual reality (VR), etc., involve understanding three-dimensional (3D) geometry and the semantics of a scene. The underlying 3D data is often in the form of a point cloud or voxels that provides a natural and expressive representation of a 3D scene. State of the art deep learning methods for different 3D scene understanding tasks may perform multiply and accumulate (MAC) operations directly on 3D point clouds that are spatially sparse (e.g., as much as 95% of the points contain no data). The spatial sparsity in 3D data results in irregular data accesses and compute patterns leading to poor utilization and energy efficiency problems in CPU (central processing unit, e.g., host processor) and/or GPU (graphics processing unit) based implementations.

While recent developments may have been made in using sparse accelerator hardware to convert/rearrange the sparse data into a dense metadata format, there remains considerable room for improvement. More particularly, with this metadata format, the utilization and energy efficiency problems are addressed to some extent but eventually two additional problems result: 1) increased occurrence of memory transactions due to limited data reuse and 2) increased partial data (e.g., data associated intermediate MAC operations). The increased memory transactions may have a negative impact on performance (e.g., compute utilization) and solutions to handling the increased partial data typically lead to increased circuit area and/or power consumption.

### BRIEF DESCRIPTION OF THE DRAWINGS

The various advantages of the embodiments will become apparent to one skilled in the art by reading the following specification and appended claims, and by referencing the following drawings, in which:

FIG. 1 is a comparative illustration of an example of a conventional partial accumulation and an enhanced partial accumulation according to an embodiment;

FIG. 2 is a comparative illustration of an example of a conventional stall event and an enhanced stall event according to an embodiment;

FIG. 3 is a block diagram of an example of a memory interface according to an embodiment;

FIG. 4 is a schematic diagram of an example of a circuit to detect memory bank collisions according to an embodiment;

FIG. 5 is a schematic diagram of an example of a check buffer according to an embodiment;

FIG. 6 is a block diagram of an example of a check buffer to handle latency conditions according to an embodiment;

FIG. 7 is a comparative chart of an example of conventional compute utilization results and enhanced compute utilization results according to an embodiment;

FIG. 8 is a comparative chart of an example of conventional memory transaction results and enhanced memory transaction results according to an embodiment;

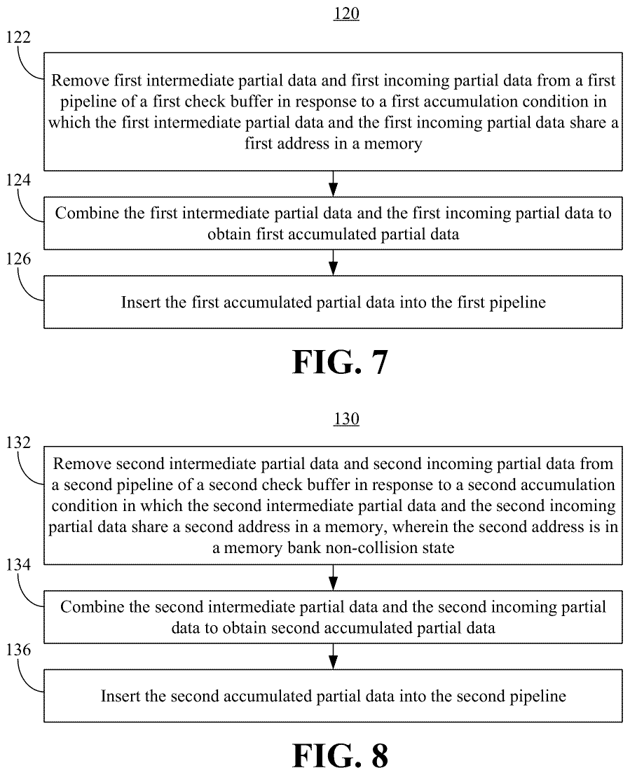

FIG. 7 is a flowchart of an example of a method of operating a check buffer according to an embodiment;

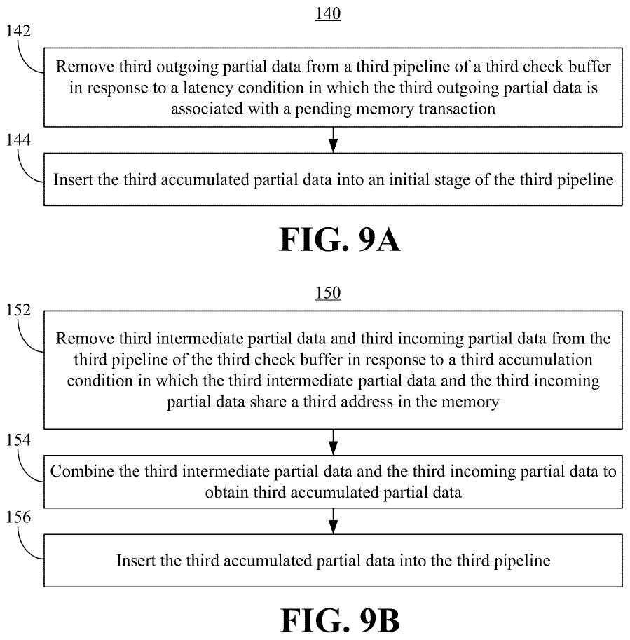

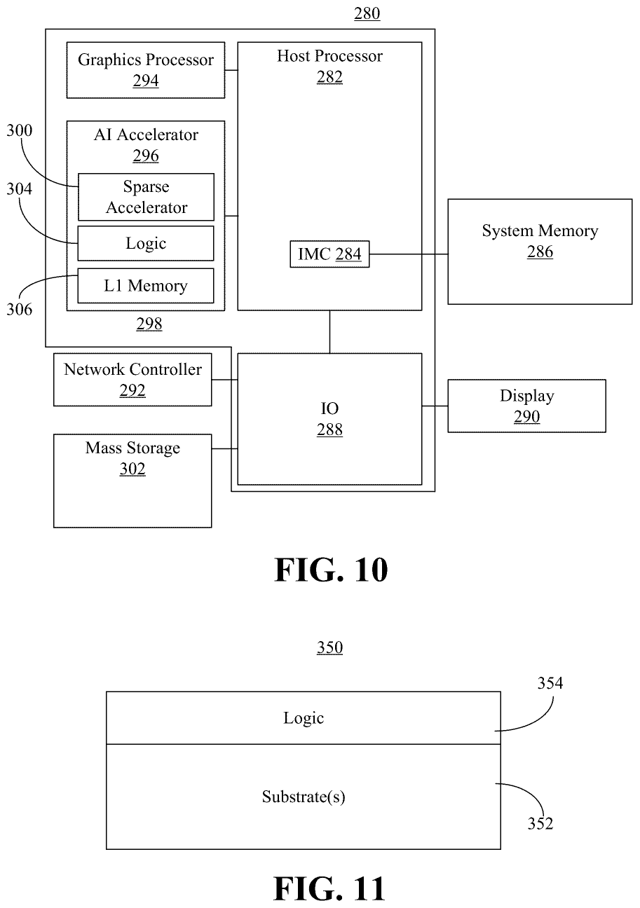

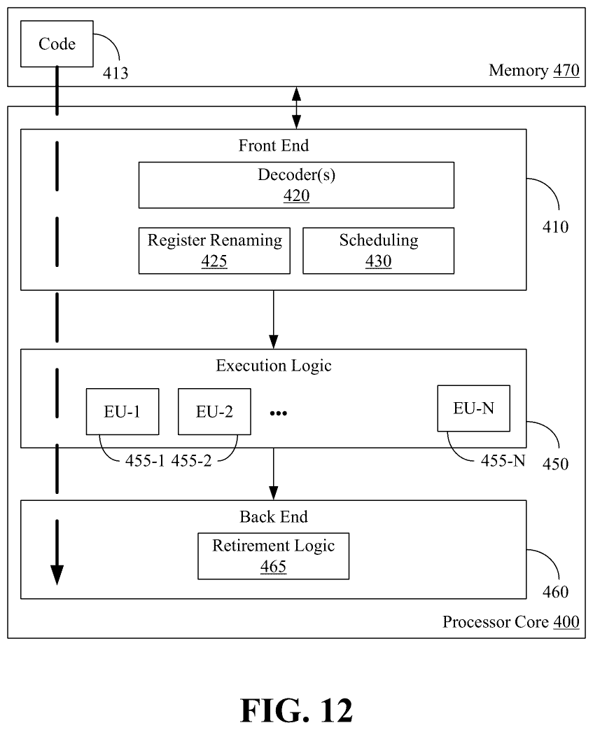

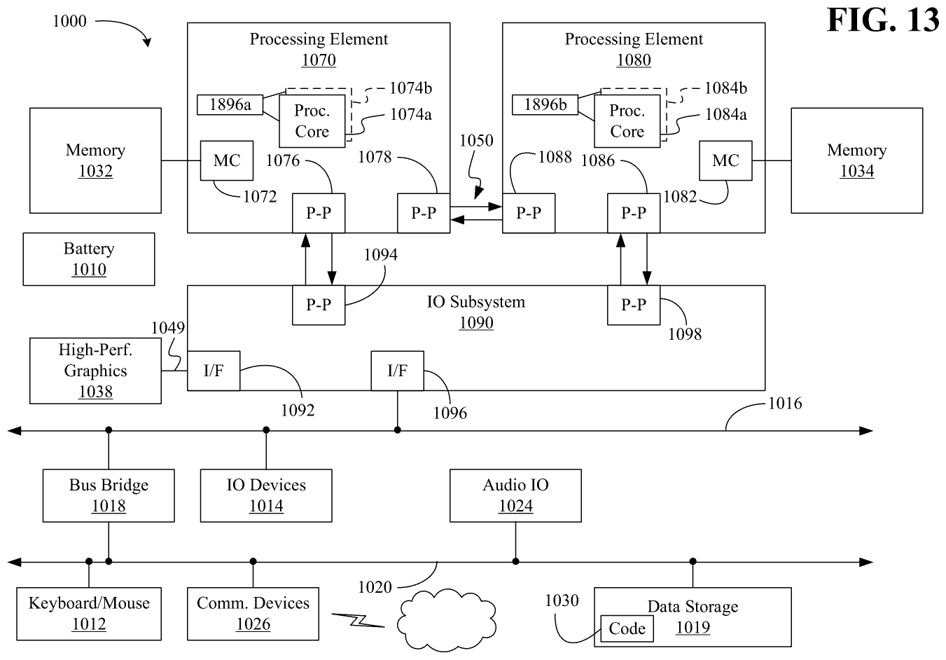

FIG. 8 is a flowchart of an example of a method of operating a check buffer to handle addresses that are in a memory bank non-collision state according to an embodiment;

FIGS. 9A and 11B are flowcharts of examples of methods of operating a check buffer to handle latency conditions according to an embodiment;

FIG. 10 is a block diagram of an example of a performance-enhanced computing system according to an embodiment;

FIG. 11 is an illustration of an example of a semiconductor package apparatus according to an embodiment;

FIG. 12 is a block diagram of an example of a processor according to an embodiment; and

FIG. 13 is a block diagram of an example of a multi-processor based computing system according to an embodiment.

### DETAILED DESCRIPTION

As already noted, deep learning methods for different three-dimensional (3D) scene understanding tasks may perform multiply and accumulate (MAC) operations directly on 3D point clouds that are spatially sparse, wherein the spatial sparsity in 3D data results in irregular data accesses and compute patterns leading to poor utilization and energy efficiency problems. Using a sparse accelerator (e.g., pre-processor hardware module) to convert/rearrange the sparse data into a dense metadata format may result in an increased occurrence of memory transactions due to limited data reuse and increased amounts of partial data (e.g., data associated intermediate MAC operations).

Attempting to optimize scheduling for data reuse may result in an even greater amount partial data. To handle partial data, hardware may either use a local temporary memory (e.g., scratchpad) or rely on existing memory in the memory hierarchy to perform read-accumulate-write operations. For a given application space and with such a metadata structure, it may not be possible to restrict the partial data generation to a limited output space (e.g., the data can scatter to any output channel of the Output Feature Map/OFM). Accordingly, adding a temporary memory can limit the overall performance (e.g., frequent stalls will be issued to the compute engines once the temporary memory is full). Frequent reading and writing to the memory also increases the overall power budget. Since in real world artificial intelligence (AI) problems such as autonomous driving, automated machines, remote sensing, augmented reality (AR), virtual reality (VR), etc., the amount of the data to be processed is substantial, and partial data handling becomes even more critical. Moreover, with an increase in the dimensionality (e.g., from 3D to four-dimensional/4D and/or five-dimensional/5D), the relationship between input and output voxel also increases exponentially, which in turn leads to more partial data to handle.

The technology described herein provides an on-the-fly partial data handling approach and an efficient hardware solution to support the data handling. The performance of the proposed hardware does not depend on the exact dimension of the application (N-dimensional scene understanding). The technology described herein does not incorporate extra memory, increase memory transactions, or stall the compute engines (e.g., processing engines/MAC engines). Further, the technology described herein does not have a negative impact on performance, area or power when deployed with existing sparse hardware in this domain.

Embodiments include hardware that handles the accumulation of partial data efficiently for N-dimensional scene understanding. More particularly, the technology described herein includes a check buffer having a set of registers arranged in a pipelined fashion (e.g., Stage 1 to Stage n) and one or more control blocks to navigate the data flow through the stages. The control block(s) keeps track of addresses corresponding to the data in the check buffer. If any address of the incoming partial data matches with any address in the check buffer, those entries are removed (e.g., “popped”) from the pipeline (e.g., irrespective of their current position in the pipe), accumulated and inserted (e.g., fed back) to the tail (e.g., Stage 1) of the pipeline. This approach ensures that the check buffer pipeline contains only unique entries of the partial data, with the most updated values.

Such an approach is different from a bypass network, which can only pop the data on the head of pipeline. Bypass networks are typically used in general-purpose execution engines that can send the output data directly back to the input of another or same compute unit without being written to the memory. A bypass network/engine cannot trace the addresses of all the entries anywhere in the pipeline to pop and accumulate the entries before sending the accumulated results back to the tail of the pipeline. Rather, the head (e.g., Stage n) of the check buffer sends a request to the memory to obtain a previous partial result, wherein the check buffer writes the most updated partial data to the memory after accumulating partial data from the memory with the partial data from the pipeline.

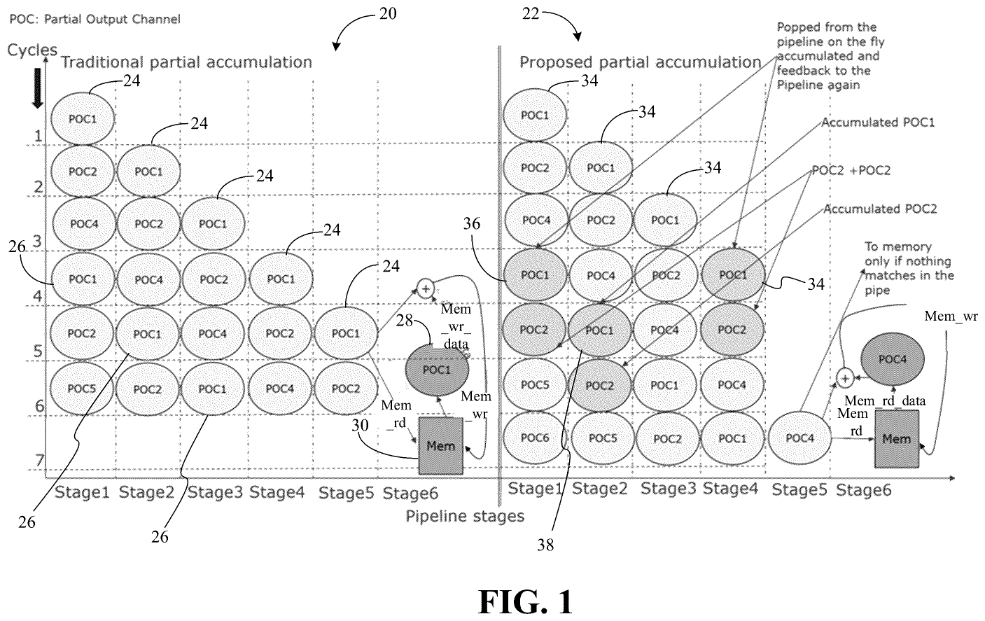

FIG. 1 shows a traditional partial accumulation 20 and an enhanced partial accumulation 22 according to the technology described herein. In the traditional partial accumulation 20, a first result 24 of a first partial output channel (POC, e.g., “POC1” containing partial data) enters a pipeline at a first/initial stage (“Stage1”, e.g., tail of the pipeline) during a first cycle. The illustrated first result 24 of the POC1 propagates through the pipeline and a second result 26 of the POC1 (e.g., containing additional partial data) enters the pipeline at the first stage during a fourth cycle. The first result 24 of the POC1 and the second result 26 of the POC1 continue to propagate through the pipeline and an accumulation result 28 of the POC1 is retrieved from a memory 30 at a sixth stage (“Stage6”, e.g., head of the pipeline) during a sixth cycle (e.g., in conjunction with a read request/Mem_rd transaction and a response/Mem_rd_data transaction). Additionally, the first result 24 of the POC1 is summed with the accumulation result 28 of the POC1, where the result of the summation is written back to the memory 30 (e.g., in conjunction with a write request/Mem_wr transaction). The illustrated second result 26 of the POC1 continues to propagate through the pipeline during the sixth cycle.

In the enhanced partial accumulation 22, a first result 34 of a first POC (“POC1” containing partial data) enters a pipeline at a first stage (“Stage1”, e.g., tail of the pipeline) during a first cycle. The illustrated first result 34 of the POC1 propagates through the pipeline and a second result 36 of the POC1 (e.g., containing additional partial data) enters the pipeline at the first stage during a fourth cycle. Rather than continuing to propagate through the pipeline, the first result 34 of the POC1 and the second result 36 of the POC1 are removed (e.g., popped) from the pipeline and combined (e.g., accumulated, summed) together to obtain an accumulated result 38 (e.g., accumulated partial data). The accumulated result 38 is inserted back into the pipeline at a subsequent stage (e.g., second stage/“Stage2” after the initial stage) during a fifth cycle. Thus, the accumulation is achieved locally without conducting a memory read request, response or write request transaction as in the traditional partial accumulation 20. Rather, such memory transactions are only conducted when a result of a POC (e.g., “POC4”) reaches the head of the pipeline without matching another result in the pipeline (“pipe”). Similar benefits are achieved with respect to the partial data results of a second POC (“POC2”) in the illustrated example.

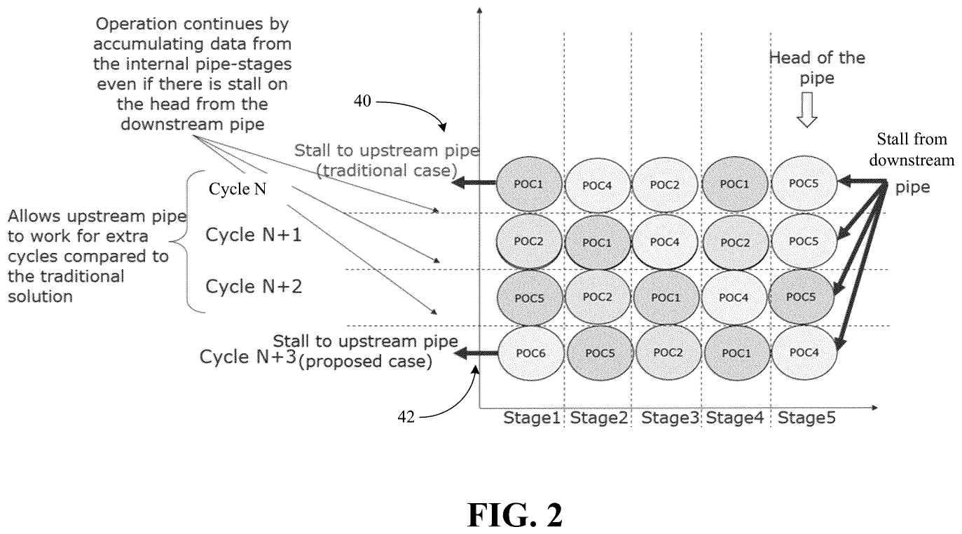

Turning now to FIG. 2, a conventional upstream stall event 40 is shown with respect to an upstream pipe. In the illustrated example, the conventional upstream stall event 40 is triggered at Cycle N in response to a downstream stall event because the downstream pipe is unable to accept POC5. By contrast, an enhanced upstream stall event 42 is triggered at Cycle N+3 (e.g., three cycles later) only when POC4 reaches the head of the pipeline without matching another result in the pipeline. Thus, the bypass network used in the general-purpose execution engines can still apply backpressure to the upstream pipe if the downstream pipe is stalled. In the technology described herein, even if the downstream pipe is stalled, local accumulation can be carried out and the upstream pipe can operate relatively longer than the traditional solution (e.g., increasing compute utilization). Moreover, a bypass network does not have a capability to trace the addresses of the partial data in the pipeline, pop the matching entries from any arbitrary stage of the pipeline and feedback the updated data to the tail of the pipeline after performing the accumulation. This solution is only achievable with the technology described herein.

As will be discussed in greater detail, embodiments include a check buffer, which is hardware that can perform on-the-fly partial data accumulation by tracing the addresses of all the entries in the pipeline. If a match is found, the check buffer pops the entries irrespective of their position in the pipeline and feeds the popped entries to the tail of the pipeline after accumulation. Also, if all requirements are clear, the check buffer can initiate a memory request to accumulate partial data from the memory with the partial data from the pipeline and write the updated data back to the memory.

Embodiments also include “check buffer inter” hardware that can perform on-the-fly partial data accumulation for a multicycle latency memory with a check buffer. All operations in the check buffer remain intact, but while sending the memory request for an entry at the head of the pipeline, the check buffer will look for a clear signal from the check buffer inter. Otherwise, the data will be circulated back to the tail of the check buffer. In one example, the check buffer inter includes a check buffer and a memory latency matching FIFO (first in first out). The check buffer inter can trace the addresses for data across all stages of the pipeline similarly to a check buffer and stall the memory request from the check buffer for those entries for which a memory read request is already issued or read/write requests are inflight (e.g., avoiding read before write type of hazards).

More particularly, for any system with memory latency greater than one, the check buffer inter is introduced. The check buffer inter includes a check buffer and a memory read/write latency FIFO (first in first out) to avoid “read before write” types of hazards. This latency protection is achieved by stalling the check buffer from sending the memory request again to the same entry for which a read/write request is already inflight and gives more flexibility to merge large amounts of partial data locally before writing back to the memory. Once stalled by the check buffer inter for the above-mentioned scenario, the data from the head of the check buffer is circulated back to the tail of the pipeline to unblock the further pipeline progress. Sending the accumulated or stalled partials back to the tail of the pipeline provides time to accumulate more partial data before writing the accumulated data back to the memory while also not stalling unique requests behind an inflight request. Connecting check buffer and check buffer inter instances back-to-back provides a relatively deeper pipeline to make on-the-fly accumulation even more effective.

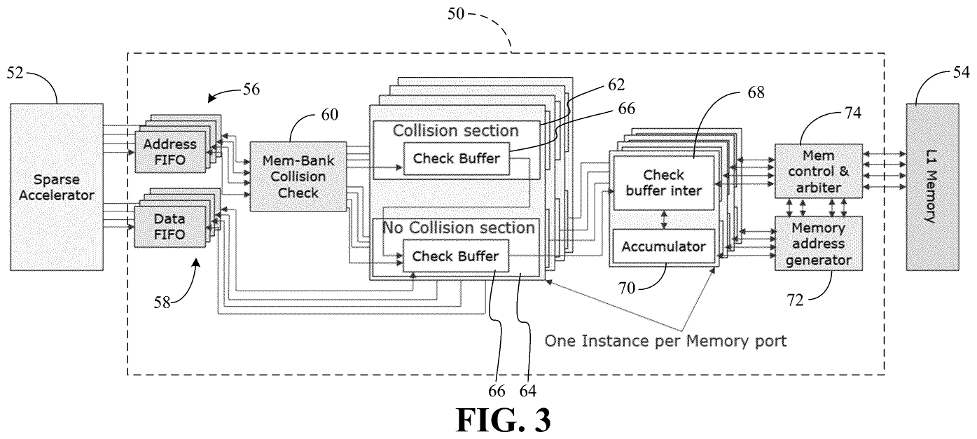

Turning now to FIG. 3 a memory interface 50 is shown in which a sparse accelerator 52 (e.g., including multiple instances of compute engines/MAC units) generates partial data in a dense metadata format for a multi-ported L1 (level one) memory 54 (e.g., static random access memory/SRAM). Each compute engine can provide one partial data with a corresponding address. The data and address from the sparse accelerator 52 are stored in a data FIFO 58 and an address FIFO 56, respectively. To avoid writing to the same region of the memory 54 through multiple ports, the upper two bits (2-MSB/most significant bits) can be used to select a logical bank of the memory 54. Thus, a collision check circuit 60 avoids such collisions to the same bank through multiple ports of the memory 54. A no collision section 64 receives the instances of the partial data that have no collision with other partial data co-dispatched by the sparse accelerator 52. A collision section 62 receives the instances of the partial data that have contention with other partial data co-dispatched by the sparse accelerator 52.

A check buffer 66 is responsible for local accumulation of the partial data inside both the collision section 62 as well as the no collision section 64 (e.g., using two independent instances). Once the check buffer 66 ensures that none of the partial data belonging to the same address are in the pipeline, the data at the head (e.g., Stage n) of the check buffer 66 is passed on to the next phase of the memory interface 50. If the check buffer 66 is inside the collision section 62, the data and address of the partial data at the head (Stage n) is passed on to the no collision section 64. If the check buffer 66 is inside the no collision section 64, the data and address of the partial data at the head (Stage n) are passed on to a check buffer inter 68.

The check buffer inter 68 functions similar to that of the check buffer 66 by performing on-the-fly accumulation. In addition, however, the check buffer inter 68 accounts for the L1 memory 54 read/write latency to ensure that the most updated partial data is written to the memory 54 without any read before write kind of hazard. An accumulator 70 associated with the check buffer inter 68 accumulates partial data from the memory 54 with updated partial data from the pipeline in the check buffer inter 68. Address generation and memory arbitration are handled by an address generator 72 and a control and arbiter 74, respectively. The collision section 62 and the no collision section 64, along with the check buffer inter 68 are instantiated once per memory port to match the targeted throughput.

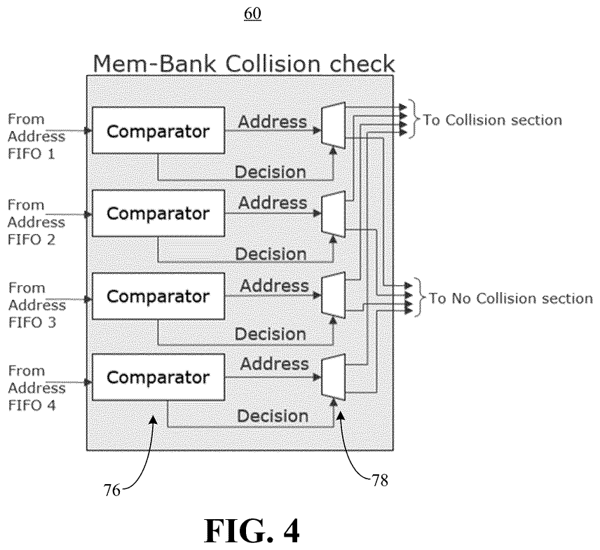

With continuing reference to FIGS. 3 and 4, the illustrated collision check circuit 60 includes a set of comparators 76 and a set of demultiplexers 78. An address from the address FIFO 56 is read and compared against the logical bank address (e.g., which is determined by 2-MSB bits of the address). Based on this comparison, the appropriate data is routed to the collision section 62 or the no collision section 64. The total number of comparators 76 depends on the number of parallel compute engines employed in the sparse accelerator 52. The number of demultiplexers 78 is determined by the number of ports in the L1 memory 54.

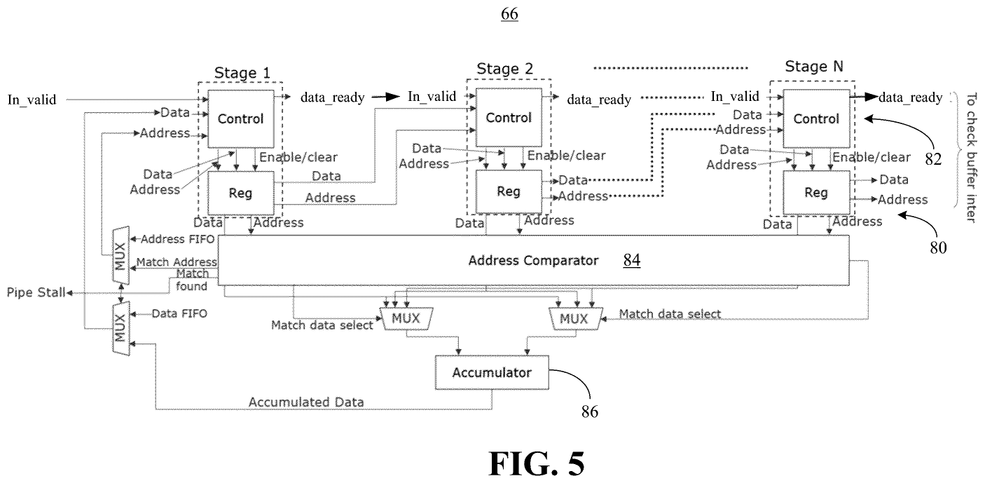

With continuing reference to FIGS. 3 and 5, the internal details of the check buffer 66 are shown. In the illustrated example, the check buffer 66 includes registers 80, which can hold address and data from their respective FIFO 56, 58, and a control block 82 to determine the type of operations to be performed. An address from each register 80 is feed to an address comparator 84. Wherever there is a match of address between any register 80 from any stage, the data corresponding to those addresses are passed on to the accumulator 84. After an accumulator 86 combines the partial data, the accumulated partial data is written to Stage 1 of the check buffer 66. The control blocks 82 also ensure that the data and address continues to propagate to the next and subsequent stages every cycle for the entries to which no matches were found. This on-the-fly accumulation ensures that only unique addresses of partial data are available inside the check buffer 66. Thus, significant savings are achieved compared to the traditional partial accumulation techniques, which involve one memory access per address in the pipeline (e.g., irrespective of their recurrence).

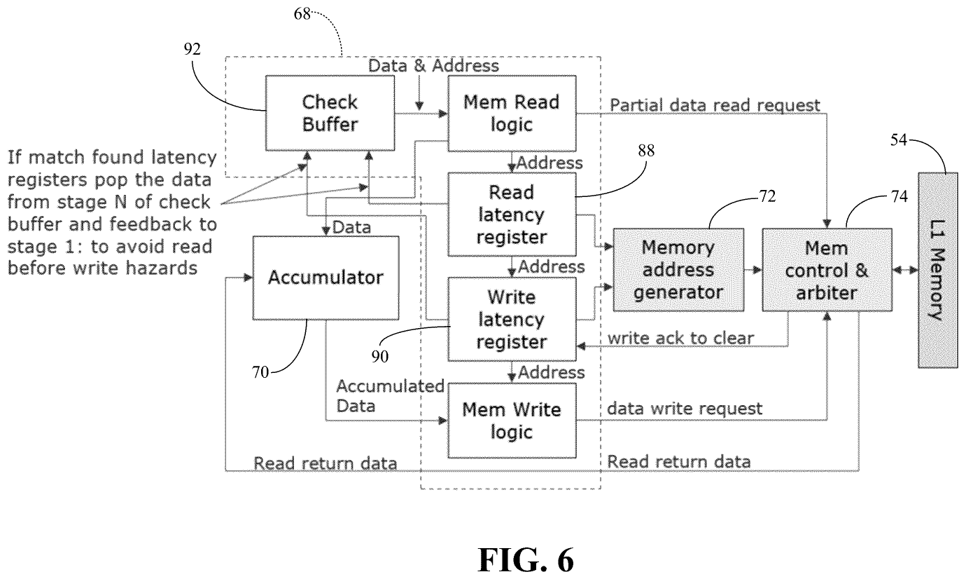

With continuing reference to FIGS. 3 and 6, the internal details of the check buffer inter 68 are shown. As already mentioned, the check buffer inter 68 can be deployed only when the memory read/write latency is greater than one cycle. In such a case, the check buffer 66 may suffer from read before write hazards as before updating the partial data to the memory 54, read requests for that data might be requested for accumulation. This condition will result in incorrect partial data being computed by the hardware. Thus, the check buffer inter 68 instantiates two additional registers: 1) a read latency register 88 and 2) a write latency register 90. A check buffer 92 within the check buffer inter 68 compares addresses not only from the registers inside the check buffer 92, but also addresses from the read latency register 88 and the write latency register 90. If a match is found from the latency registers 88, 90, the accumulated data is fed to the accumulator 70 instead of the tail (e.g., stage 1) of the check buffer 92. This approach ensures that only the latest updated partial data from the check buffer inter 68 is accumulated with the corresponding entry of the partial data from the memory 54.

Another benefit provided by the technology described herein is less circuit area. For example, a local memory module deep enough and wide enough to support the partial data would be significantly larger than a check buffer with enough stages to support the same amount of partial data. Similarly, a local memory with extra depth to account for L1 memory read-write latency would be significantly larger than a check buffer inter as described herein. Other benefits provided by the technology described herein include reduced overall execution time of the workload (e.g., enabled by on-the-fly accumulation and the bypassing of frequent memory accesses) and less power consumption (e.g., providing suitability for lower power applications). The technology described herein also provides significant advantages in terms of compute utilization and reduction in memory transactions across different workloads.

FIG. 7 shows a method 120 of operating a check buffer. The method 120 may generally be implemented in a check buffer such as, for example, the check buffer 66 (FIGS. 3 and 5), already discussed. More particularly, the method 120 may be implemented in one or more modules as a set of logic instructions (e.g., executable program instructions) stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 120 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 122 provides for removing first intermediate partial data and first incoming partial data from a first pipeline of a first check buffer in response to a first accumulation condition in which the first intermediate partial data and the first incoming partial data share a first address in a memory. In one example, block 122 removes the first intermediate partial data from an intermediate stage of the first pipeline and removes the first incoming partial data from an initial stage (e.g., Stage 1) of the first pipeline. In an embodiment, the first address is in a memory bank collision state (e.g., the first address targets the same memory bank as another address currently being processed). Block 124 combines (e.g., adds, accumulates) the first intermediate partial data and the first incoming partial data to obtain first accumulated partial data and block 126 inserts the first accumulated partial data into the first pipeline. In one example, block 126 inserts the first accumulated partial data into a subsequent stage (e.g., Stage 2) after the initial stage of the first pipeline. The method 120 therefore enhances performance at least to the extent that using the check buffer to accumulate intermediate partial data reduces memory transactions, increases compute utilization (e.g., through reduced back pressure on the compute engines), reduces circuit area, improves multi-ported memory scalability, decreases overall execution time and/or decreases power consumption.

FIG. 8 shows a method 130 of operating a check buffer to handle addresses that are in a memory bank non-collision state (e.g., addresses do not target the same memory bank other addresses currently being processed). The method 130 may generally be implemented in conjunction with the method 120 (FIG. 7) in a no collision section such as, for example, the no collision section 64 (FIG. 3), already discussed. More particularly, the method 130 may be implemented in one or more modules as a set of logic instructions stored in a machine- or computer-readable storage medium such as RAM, ROM, PROM, firmware, flash memory, etc., in hardware, or any combination thereof.

Illustrated processing block 132 provides for removing second intermediate partial data and second incoming partial data from a second pipeline of a second check buffer in response to a second accumulation condition in which the second intermediate partial data and the second incoming partial data share a second address in memory, wherein the second address is in the memory bank non-collision state. Block 134 combines (e.g., adds, accumulates) the second intermediate partial data and the second incoming partial data to obtain second accumulated partial data and block 136 inserts the second accumulated partial data into the second pipeline (e.g., at or near the tail of the second pipeline). The method 130 therefore enhances performance at least to the extent that using the check buffer to accumulate intermediate partial data reduces memory transactions, increases compute utilization (e.g., through reduced back pressure on the compute engines), reduces circuit area, improves multi-ported memory scalability, decreases overall execution time and/or decreases power consumption.

FIG. 9A shows a method 140 of operating a check buffer to handle latency conditions. The method 140 may generally be implemented in conjunction with the method 120 (FIG. 7) and/or the method 130 (FIG. 8) in a check buffer inter such as, for example, the check buffer inter 68 (FIGS. 3 and 6), already discussed. More particularly, the method 140 may be implemented in one or more modules as a set of logic instructions stored in a machine- or computer-readable storage medium such as RAM, ROM, PROM, firmware, flash memory, etc., in hardware, or any combination thereof.

Illustrated processing block 142 removes third outgoing partial data from a third pipeline of a third check buffer in response to a latency condition in which the third outgoing partial data is associated with a pending memory transaction (e.g., read latency register and/or write latency register). Block 144 inserts the third accumulated partial data into an initial stage of the third pipeline. The method 140 therefore further enhances performance at least to the extent that feeding the outgoing partial data back into the pipeline avoids read before write types of hazards (e.g., ensuring that only the latest updated partial data from the check buffer inter is accumulated with the corresponding entry of the partial data from the memory).

FIG. 9B shows another method 150 of operating a check buffer to handle latency conditions. The method 140 may generally be implemented in conjunction with the method 120 (FIG. 7), the method 130 (FIG. 8) and/or the method 140 (FIG. 9A) in a check buffer inter such as, for example, the check buffer inter 68 (FIGS. 3 and 6), already discussed. More particularly, the method 150 may be implemented in one or more modules as a set of logic instructions stored in a machine- or computer-readable storage medium such as RAM, ROM, PROM, firmware, flash memory, etc., in hardware, or any combination thereof.

Illustrated processing block 152 provides for provides for removing third intermediate partial data and third incoming partial data from the third pipeline of the third check buffer in response to a third accumulation condition in which the third intermediate partial data and the third incoming partial data share a third address in memory. Block 154 combines (e.g., adds, accumulates) the third intermediate partial data and the third incoming partial data to obtain third accumulated partial data and block 156 inserts the third accumulated partial data into the third pipeline (e.g., at or near the tail of the third pipeline). The method 150 therefore enhances performance at least to the extent that using the check buffer to accumulate intermediate partial data reduces memory transactions, increases compute utilization (e.g., through reduced back pressure on the compute engines), reduces circuit area, improves multi-ported memory scalability, decreases overall execution time and/or decreases power consumption.

Turning now to FIGS. 10, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298. In an embodiment, the AI accelerator 296 includes a sparse accelerator 300, an L1 memory 306 and logic 304 (e.g., memory interface including one or more of configurable or fixed-functionality hardware) coupled to the sparse accelerator 300 and the L1 memory 306.

The logic 304 performs one or more aspects of the method 120 (FIG. 7), the method 130 (FIG. 8), the method 140 (FIG. 9A) and/or the method 150 (FIG. 9B), already discussed. Thus, the logic 304 includes one or more check buffers to remove intermediate partial data and incoming partial data from a pipeline of the check buffer(s) in response to an accumulation condition in which the intermediate partial data and the incoming partial data share an address in the L1 memory 306. The logic 304 also combines the intermediate partial data and the incoming partial data to obtain accumulated partial data and inserts the accumulated partial data into the pipeline. The computing system 280 is therefore considered performance-enhanced at least to the extent that that using the check buffer to accumulate intermediate partial data reduces memory transactions, increases compute utilization (e.g., through reduced back pressure on the compute engines), reduces circuit area, improves multi-ported memory scalability, decreases overall execution time and/or decreases power consumption.

FIG. 11 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. The logic 354 can be readily substituted for the logic 304 (FIG. 10), already discussed. In an embodiment, the logic 354 implements one or more aspects of the method 120 (FIG. 7), the method 130 (FIG. 8), the method 140 (FIG. 9A) and/or the method 150 (FIG. 9B), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

FIG. 12 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIGS. 12, a processing element may alternatively include more than one of the processor core 400 illustrated in FIG. 12. The processor core 400 may be a single-threaded core or, for at least one embodiment, the processor core 400 may be multithreaded in that it may include more than one hardware thread context (or “logical processor”) per core.

FIG. 12 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 120 (FIG. 7), the method 130 (FIG. 8), the method 140 (FIG. 9A) and/or the method 150 (FIG. 9B), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIGS. 12, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

Referring now to FIGS. 13, shown is a block diagram of a computing system 1000 embodiment in accordance with an embodiment. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIGS. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIGS. 13, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIGS. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIGS. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 120 (FIG. 7), the method 130 (FIG. 8), the method 140 (FIG. 9A) and/or the method 150 (FIG. 9B), already discussed. Further, an audio I/O 1024 may be coupled to second bus 1020 and a battery 1010 may supply power to the computing system 1000.

Note that other embodiments are contemplated. For example, instead of the point-to-point architecture of FIGS. 13, a system may implement a multi-drop bus or another such communication topology. Also, the elements of FIG. 13 may alternatively be partitioned using more or fewer integrated chips than shown in FIG. 13.

### Additional Notes and Examples

Example 1 includes a performance-enhanced computing system comprising a sparse accelerator, a memory, and a memory interface coupled to the sparse accelerator and the memory, the memory interface including logic coupled to one or more substrates, wherein the logic includes a first check buffer to remove first intermediate partial data and first incoming partial data from a first pipeline of the first check buffer in response to a first accumulation condition in which the first intermediate partial data and the first incoming partial data share a first address in the memory, combine the first intermediate partial data and the first incoming partial data to obtain first accumulated partial data, and insert the first accumulated partial data into the first pipeline.

Example 2 includes the computing system of Example 1, wherein the first intermediate partial data is removed from an intermediate stage of the first pipeline and the first incoming partial data is removed from an initial stage of the first pipeline.

Example 3 includes the computing system of Example 2, wherein the first accumulated partial data is inserted into a subsequent stage after the initial stage of the first pipeline.

Example 4 includes the computing system of any one of Examples 1 to 3, wherein the first address is to be in a memory bank collision state.

Example 5 includes the computing system of Example 4, wherein the logic further includes a second check buffer, the second check buffer to remove second intermediate partial data and second incoming partial data from a second pipeline of the second check buffer in response to a second accumulation condition in which the second intermediate partial data and the second incoming partial data share a second address in the memory, wherein the second address is to be in a memory bank non-collision state, combine the second intermediate partial data and the second incoming partial data to obtain second accumulated partial data, and insert the second accumulated partial data into the second pipeline.

Example 6 includes the computing system of any one of Examples 1 to 4, wherein the logic further includes a third check buffer, the third check buffer to remove third outgoing partial data from a third pipeline of the third check buffer in response to a latency condition in which the third outgoing partial data is associated with a pending memory transaction, insert the third outgoing partial data into an initial stage of the third pipeline, remove third intermediate partial data and third incoming partial data from the third pipeline in response to a third accumulation condition in which the third intermediate partial data and the third incoming partial data share a third address in the memory, combine the third intermediate partial data and the third incoming partial data to obtain third accumulated partial data, and insert the third accumulated partial data into the third pipeline.

Example 7 includes a semiconductor apparatus comprising one or more substrates, and logic coupled to the one or more substrates, wherein the logic includes a first check buffer and is implemented at least partly in one or more of configurable or fixed-functionality hardware, the first check buffer to remove first intermediate partial data and first incoming partial data from a first pipeline of the first check buffer in response to a first accumulation condition in which the first intermediate partial data and the first incoming partial data share a first address in a memory, combine the first intermediate partial data and the first incoming partial data to obtain first accumulated partial data, and insert the first accumulated partial data into the first pipeline.

Example 8 includes the semiconductor apparatus of Example 7, wherein the first intermediate partial data is removed from an intermediate stage of the first pipeline and the first incoming partial data is removed from an initial stage of the first pipeline.

Example 9 includes the semiconductor apparatus of Example 8, wherein the first accumulated partial data is inserted into a subsequent stage after the initial stage of the first pipeline.

Example 10 includes the semiconductor apparatus of any one of Examples 7 to 9, wherein the first address is to be in a memory bank collision state.

Example 11 includes the semiconductor apparatus of Example 10, wherein the logic further includes a second check buffer, the second check buffer to remove second intermediate partial data and second incoming partial data from a second pipeline of the second check buffer in response to a second accumulation condition in which the second intermediate partial data and the second incoming partial data share a second address in the memory, wherein the second address is to be in a memory bank non-collision state, combine the second intermediate partial data and the second incoming partial data to obtain second accumulated partial data, and insert the second accumulated partial data into the second pipeline.

Example 12 includes the semiconductor apparatus of any one of Examples 7 to 10, wherein the logic further includes a third check buffer, the third check buffer to remove third outgoing partial data from a third pipeline of the third check buffer in response to a latency condition in which the third outgoing partial data is associated with a pending memory transaction, and insert the third outgoing partial data into an initial stage of the third pipeline.

Example 13 includes the semiconductor apparatus of Example 12, wherein the third check buffer is further to remove third intermediate partial data and third incoming partial data from the third pipeline in response to a third accumulation condition in which the third intermediate partial data and the third incoming partial data share a third address in the memory, combine the third intermediate partial data and the third incoming partial data to obtain third accumulated partial data, and insert the third accumulated partial data into the third pipeline.

Example 14 includes at least one computer readable storage medium comprising a set of instructions, which when executed by a computing system, cause the computing system to remove, by a first check buffer, first intermediate partial data and first incoming partial data from a first pipeline of the first check buffer in response to a first accumulation condition in which the first intermediate partial data and the first incoming partial data share a first address in a memory, combine, by the first check buffer, the first intermediate partial data and the first incoming partial data to obtain first accumulated partial data, and insert, by the first check buffer, the first accumulated partial data into the first pipeline.

Example 15 includes the at least one computer readable storage medium of Example 14, wherein the first intermediate partial data is removed from an intermediate stage of the first pipeline and the first incoming partial data is removed from an initial stage of the first pipeline.

Example 16 includes the at least one computer readable storage medium of Example 15, wherein the first accumulated partial data is inserted into a subsequent stage after the initial stage of the first pipeline.

Example 17 includes the at least one computer readable storage medium of any one of Examples 14 to 16, wherein the first address is to be in a memory bank collision state.

Example 18 includes the at least one computer readable storage medium of Example 17, wherein the instructions, when executed, further cause the computing system to remove, by a second check buffer, second intermediate partial data and second incoming partial data from a second pipeline of the second check buffer in response to a second accumulation condition in which the second intermediate partial data and the second incoming partial data share a second address in the memory, wherein the second address is to be in a memory bank non-collision state, combine, by the second check buffer, the second intermediate partial data and the second incoming partial data to obtain second accumulated partial data, and insert, by the second check buffer, the second accumulated partial data into the second pipeline.

Example 19 includes the at least one computer readable storage medium of any one of Examples 14 to 17, wherein the instructions, when executed, further cause the computing system to remove, by a third check buffer, third outgoing partial data from a third pipeline of the third check buffer in response to a latency condition in which the third outgoing partial data is associated with a pending memory transaction, and insert, by the third check buffer, the third outgoing partial data into an initial stage of the third pipeline.

Example 20 includes the at least one computer readable storage medium of Example 19, wherein the instructions, when executed, further cause the computing system to remove, by the third check buffer, third intermediate partial data and third incoming partial data from the third pipeline in response to a third accumulation condition in which the third intermediate partial data and the third incoming partial data share a third address in the memory, combine, by the third check buffer, the third intermediate partial data and the third incoming partial data to obtain third accumulated partial data, and insert, by the third check buffer, the third accumulated partial data into the third pipeline.

Example 21 includes a method of operating a performance-enhanced computing system, the method comprising removing first intermediate partial data and first incoming partial data from a first pipeline of the first check buffer in response to a first accumulation condition in which the first intermediate partial data and the first incoming partial data share a first address in a memory, combining, by the first check buffer, the first intermediate partial data and the first incoming partial data to obtain first accumulated partial data, and inserting, by the first check buffer, the first accumulated partial data into the first pipeline.

Example 22 includes an apparatus comprising means for performing the method of Example 21.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a sparse accelerator;
a memory; and
a memory interface coupled to the sparse accelerator and the memory, the memory interface including logic coupled to one or more substrates, wherein the logic includes a first check buffer to:
remove first intermediate partial data and first incoming partial data from a first pipeline of the first check buffer in response to a first accumulation condition in which the first intermediate partial data and the first incoming partial data share a first address in the memory,
combine the first intermediate partial data and the first incoming partial data to obtain first accumulated partial data, and
insert the first accumulated partial data into the first pipeline.

2. The computing system of claim 1, wherein the first intermediate partial data is removed from an intermediate stage of the first pipeline and the first incoming partial data is removed from an initial stage of the first pipeline.

3. The computing system of claim 2, wherein the first accumulated partial data is inserted into a subsequent stage after the initial stage of the first pipeline.

4. The computing system of claim 1, wherein the first address is to be in a memory bank collision state.

5. The computing system of claim 4, wherein the logic further includes a second check buffer, the second check buffer to:
remove second intermediate partial data and second incoming partial data from a second pipeline of the second check buffer in response to a second accumulation condition in which the second intermediate partial data and the second incoming partial data share a second address in the memory, wherein the second address is to be in a memory bank non-collision state,
combine the second intermediate partial data and the second incoming partial data to obtain second accumulated partial data, and
insert the second accumulated partial data into the second pipeline.

6. The computing system of claim 1, wherein the logic further includes a third check buffer, the third check buffer to:
remove third outgoing partial data from a third pipeline of the third check buffer in response to a latency condition in which the third outgoing partial data is associated with a pending memory transaction,
insert the third outgoing partial data into an initial stage of the third pipeline,
remove third intermediate partial data and third incoming partial data from the third pipeline in response to a third accumulation condition in which the third intermediate partial data and the third incoming partial data share a third address in the memory;
combine the third intermediate partial data and the third incoming partial data to obtain third accumulated partial data; and
insert the third accumulated partial data into the third pipeline.

7. A semiconductor apparatus comprising:
one or more substrates; and
logic coupled to the one or more substrates, wherein the logic includes a first check buffer and is implemented at least partly in one or more of configurable or fixed-functionality hardware, the first check buffer to:
remove first intermediate partial data and first incoming partial data from a first pipeline of the first check buffer in response to a first accumulation condition in which the first intermediate partial data and the first incoming partial data share a first address in a memory;
combine the first intermediate partial data and the first incoming partial data to obtain first accumulated partial data; and
insert the first accumulated partial data into the first pipeline.

8. The semiconductor apparatus of claim 7, wherein the first intermediate partial data is removed from an intermediate stage of the first pipeline and the first incoming partial data is removed from an initial stage of the first pipeline.

9. The semiconductor apparatus of claim 8, wherein the first accumulated partial data is inserted into a subsequent stage after the initial stage of the first pipeline.

10. The semiconductor apparatus of claim 7, wherein the first address is to be in a memory bank collision state.

11. The semiconductor apparatus of claim 10, wherein the logic further includes a second check buffer, the second check buffer to:
remove second intermediate partial data and second incoming partial data from a second pipeline of the second check buffer in response to a second accumulation condition in which the second intermediate partial data and the second incoming partial data share a second address in the memory, wherein the second address is to be in a memory bank non-collision state;
combine the second intermediate partial data and the second incoming partial data to obtain second accumulated partial data; and
insert the second accumulated partial data into the second pipeline.

12. The semiconductor apparatus of claim 7, wherein the logic further includes a third check buffer, the third check buffer to:
remove third outgoing partial data from a third pipeline of the third check buffer in response to a latency condition in which the third outgoing partial data is associated with a pending memory transaction; and
insert the third outgoing partial data into an initial stage of the third pipeline.

13. The semiconductor apparatus of claim 12, wherein the third check buffer is further to:
remove third intermediate partial data and third incoming partial data from the third pipeline in response to a third accumulation condition in which the third intermediate partial data and the third incoming partial data share a third address in the memory;
combine the third intermediate partial data and the third incoming partial data to obtain third accumulated partial data; and
insert the third accumulated partial data into the third pipeline.

14. At least one computer readable storage medium comprising a set of instructions, which when executed by a computing system, cause the computing system to:
remove, by a first check buffer, first intermediate partial data and first incoming partial data from a first pipeline of the first check buffer in response to a first accumulation condition in which the first intermediate partial data and the first incoming partial data share a first address in a memory;
combine, by the first check buffer, the first intermediate partial data and the first incoming partial data to obtain first accumulated partial data; and
insert, by the first check buffer, the first accumulated partial data into the first pipeline.

15. The at least one computer readable storage medium of claim 14, wherein the first intermediate partial data is removed from an intermediate stage of the first pipeline and the first incoming partial data is removed from an initial stage of the first pipeline.

16. The at least one computer readable storage medium of claim 15, wherein the first accumulated partial data is inserted into a subsequent stage after the initial stage of the first pipeline.

17. The at least one computer readable storage medium of claim 14, wherein the first address is to be in a memory bank collision state.

18. The at least one computer readable storage medium of claim 17, wherein the instructions, when executed, further cause the computing system to:
remove, by a second check buffer, second intermediate partial data and second incoming partial data from a second pipeline of the second check buffer in response to a second accumulation condition in which the second intermediate partial data and the second incoming partial data share a second address in the memory, wherein the second address is to be in a memory bank non-collision state;
combine, by the second check buffer, the second intermediate partial data and the second incoming partial data to obtain second accumulated partial data; and
insert, by the second check buffer, the second accumulated partial data into the second pipeline.

19. The at least one computer readable storage medium of claim 14, wherein the instructions, when executed, further cause the computing system to:
remove, by a third check buffer, third outgoing partial data from a third pipeline of the third check buffer in response to a latency condition in which the third outgoing partial data is associated with a pending memory transaction; and
insert, by the third check buffer, the third outgoing partial data into an initial stage of the third pipeline.

20. The at least one computer readable storage medium of claim 19, wherein the instructions, when executed, further cause the computing system to:
remove, by the third check buffer, third intermediate partial data and third incoming partial data from the third pipeline in response to a third accumulation condition in which the third intermediate partial data and the third incoming partial data share a third address in the memory;
combine, by the third check buffer, the third intermediate partial data and the third incoming partial data to obtain third accumulated partial data; and
insert, by the third check buffer, the third accumulated partial data into the third pipeline.
